(19) United States
(12) Patent Application Publication
(10) Pub. No.: US 2026/0349936 A1
(43) Pub. Date: Nov. 5, 2026

(54) OPTICAL MODULE WORKING METHOD BASED ON I3C COMMUNICATION, AND OPTICAL MODULE

(71) Applicant: EOPTOLINK TECHNOLOGY INC., LTD, Chengdu City (CN)

(72) Inventors: Xiaolei Huang, Chengdu City (CN); Jun Cao, Chengdu City (CN); Pengfei He, Chengdu City (CN); Quanxiang Tang, Chengdu City (CN); Shenggang Huang, Chengdu City (CN); Shiyuan Kang, Chengdu City (CN)

(21) Appl. No.: 19/655,736

(22) Filed: Apr. 23, 2026

(30) Foreign Application Priority Data
Apr. 30, 2025 (CN) 202510558809.4

(51) Int. Cl. G06F 13/16; G06F 13/40; G06F 13/42; H04B 10/80

(52) U.S. Cl. CPC G06F 13/16; G06F 13/4068; G06F 13/4282; H04B 10/801

(57) ABSTRACT

Provided are an optical module working method based on I3C communication, and an optical module. The method includes monitoring by an optical module MCU continuously whether a dynamic address has been assigned by an I3C controller by monitoring a dynamic address update interrupt generated by an I3C peripheral; and when successful dynamic address assignment is monitored, configuring the I3C peripheral, a receiving DMA channel bound to the I3C peripheral, and a transmitting DMA channel bound to the I3C peripheral; after completing the configuration, waiting for the I3C controller to issue an operation instruction; when receiving the operation instruction, the optical module MCU responding to a private read operation or a private write operation initiated by the I3C controller.

### CROSS-REFERENCE TO RELATED APPLICATIONS

The present disclosure claims the priority to the Chinese patent application No. 202510558809.4 filed with the Chinese Patent Office on Apr. 30, 2025, and entitled “OPTICAL MODULE WORKING METHOD BASED ON I3C COMMUNICATION, AND OPTICAL MODULE”, the contents of which are incorporated herein by reference in entirety.

### TECHNICAL FIELD

The present disclosure belongs to the technical field of communications, and specifically discloses an optical module working method based on I3C communication, and an optical module.

### BACKGROUND ART

With the rapid development of modern electronic devices, the demand for communication interfaces is continuously increasing. Traditional communication buses such as I2C (Inter-Integrated Circuit) are widely used in many embedded systems due to their simplicity and efficiency.

The I2C protocol was released by Philips in 1982 and was originally configured to implement low-speed and low-cost communication between chips on a single circuit board. It uses a two-wire design, namely SDA (Serial Data Line) and SCL (Serial Clock Line), supports master-slave mode and multi-master architecture, and provides multiple communication bandwidth modes. When using the I2C protocol for optical module control and communication, the optical module receives read and write operations from the master device through the I2C SCL and SDA buses, enabling status reading, parameter configuration, and control of the I2C optical module, and the I2C data parsing uses a single-byte interrupt processing method. The existing communication method of optical modules based on the I2C protocol has the following shortcomings.
1. Bandwidth rate limitation: in practice, optical modules use I2C's "Fast Mode Plus" at most, and its maximum bandwidth is only 1 Mbps, which limits high-bandwidth data transmission.
2. Low processing efficiency of I2C interrupt mode: the module I2C uses single-byte interrupt processing when receiving data, meaning an interrupt is generated for every byte received or sent. Frequent entry of the MCU (Microcontroller Unit) into interrupts leads to problems such as low efficiency, high MCU occupancy, poor real-time performance, and high power consumption.
3. DMA (Direct Memory Access) can only handle fixed-length data issues: traditional communication peripheral DMA transmission can only transmit fixed-length data, meaning that the slave must know the length of data to be transmitted by the master in advance so that the slave can set a fixed length when initializing the DMA receive and transmit channels, which cannot meet the needs of the optical module master for dynamic data length read and write operations on the optical module slave.

To improve the communication efficiency of the optical module, the I3C (Improved Inter-Integrated Circuit) protocol is proposed as the communication protocol used for the optical module. The present disclosure aims to propose a technology for adapting the I3C communication protocol to the optical module.

### SUMMARY

The objective of the present disclosure is to provide an optical module working method based on I3C communication, and an optical module, to solve the problem of adapting the I3C communication protocol to optical modules. The specific solution is as follows.

In a first aspect, an optical module working method based on I3C communication is provided, the method includes:
monitoring, by an optical module MCU, a dynamic address update interrupt generated by an I3C peripheral, to continuously monitor whether a dynamic address has been assigned by an I3C controller; and
when successful dynamic address assignment is monitored, configuring the I3C peripheral, a receiving DMA channel bound to the I3C peripheral, and a transmitting DMA channel bound to the I3C peripheral; after completing the configuration, waiting for the I3C controller to issue an operation instruction; and
when receiving the operation instruction, responding, by the optical module MCU, to a private read operation or a private write operation initiated by the I3C controller.

Further, when successful dynamic address assignment is monitored, configuring the I3C peripheral, a receiving DMA channel bound to the I3C peripheral, and a transmitting DMA channel bound to the I3C peripheral includes configuring and enabling an I3C peripheral STOP interrupt for cooperating with the receiving DMA channel to receive variable-length data transmitted by the I3C controller, and configuring the receiving DMA channel to respond to a DMA private write operation, wherein configuring the receiving DMA channel specifically includes:
setting a source address of the receiving DMA to an I3C receiving data register in the I3C peripheral;
setting the destination address of the receiving DMA to at least two memory areas in a RAM of the optical module MCU as receiving buffers;
setting a receiving DMA receive byte length based on a maximum byte length of an extended payload page (EPL) in the CMIS protocol (common management interface specification protocol), wherein the receiving DMA receive byte length is greater than the sum of the maximum byte length of the extended payload page (EPL) and one additional byte;
enabling the receiving DMA channel; and
enabling a receiving DMA request.

Further, when successful dynamic address assignment is monitored, configuring the I3C peripheral, a receiving DMA channel bound to the I3C peripheral, and a transmitting DMA channel bound to the I3C peripheral includes configuring and enabling an I3C peripheral STOP interrupt for cooperating with the transmitting DMA channel to transmit variable-length data to the I3C controller, and configuring the transmitting DMA channel to respond to a DMA private read operation, wherein configuring the transmitting DMA channel specifically includes:
setting a source address of the transmitting DMA to one memory area in the RAM of the optical module MCU as a transmitting buffer;
setting a destination address of the transmitting DMA to an I3C transmit data register in the I3C peripheral;
setting a transmit byte length of the transmitting DMA based on the maximum byte length of the extended payload page (EPL) in the CMIS protocol, wherein the transmit byte length of the transmitting DMA is greater than maximum byte length of the extended payload page (EPL);
enabling the transmitting DMA channel; and
enabling a transmitting DMA request.

Further, the working process of the private write is as follows:
after the receiving DMA is triggered, transferring received data from a receiving DMA source address into the receiving buffer in a receiving DMA destination address; when data transmission of the private write is completed, generating an I3C peripheral STOP interrupt based on a stop bit in the data to achieve variable-length data reception by the receiving DMA;
calculating an actual received data length in the I3C peripheral STOP interrupt; configuring the I3C peripheral and the transmitting DMA channel bound to the I3C peripheral in the I3C peripheral STOP interrupt, for the optical module to respond to the next private read operation of the I3C controller;
configuring the I3C peripheral and the receiving DMA channel bound to the I3C peripheral in the I3C peripheral STOP interrupt, for the optical module to respond to the next private write operation of the I3C controller; and
processing the data in the receiving buffer based on the management memory map in the CMIS protocol.

Further, the working process of the private read is as follows:
upon the transmitting DMA being triggered, transferring, by the transmitting DMA, data from the currently configured transmitting DMA source address into the destination address of the transmitting DMA; when data transmission of the private read is completed, generating an I3C peripheral STOP interrupt based on a stop bit in the data to achieve variable-length data transmission by the transmitting DMA;
calculating an actual transmitted data length in the I3C peripheral STOP interrupt;
configuring the I3C peripheral and the transmitting DMA channel bound to the I3C peripheral in the I3C peripheral STOP interrupt, for the optical module to respond to the next private read operation of the I3C controller; and
processing the data in the transmitting buffer based on the management memory map in the CMIS protocol.

Further, the configuring the I3C peripheral and the receiving DMA channel bound to the I3C peripheral in the I3C peripheral STOP interrupt, for the optical module to respond to the next private write operation of the I3C controller specifically includes:
disabling the receiving DMA request;
disabling the receiving DMA channel;
clearing a RX-FIFO queue of the I3C;
setting a receiving DMA receive byte length based on a maximum byte length of an extended payload page (EPL) in the CMIS protocol, wherein the receiving DMA receive byte length is greater than the sum of the maximum byte length of the extended payload page (EPL) and one additional byte;
modifying the destination address of the receiving DMA to a memory area in the RAM of the optical module MCU as a receiving buffer;
enabling the receiving DMA channel; and
enabling a receiving DMA request.

Further, the configuring the I3C peripheral and the transmitting DMA channel bound to the I3C peripheral in the I3C peripheral STOP interrupt, for the optical module to respond to the next private read operation of the I3C controller specifically includes:
disabling the transmitting DMA request;
disabling the transmitting DMA channel;
clearing a TX-FIFO queue of the I3C;
setting a transmit byte length of the transmitting DMA based on the maximum byte length of the extended payload page (EPL) in the CMIS protocol, wherein the transmit byte length of the transmitting DMA is greater than maximum byte length of the extended payload page (EPL);
modifying the transmitting source address based on the optical module register address in the receiving buffer and a page mapping value of the 127th byte of Lower Memory, for the optical module to respond to the next current read operation;
enabling the transmitting DMA channel; and
enabling a transmitting DMA request.

Further, the private write operation is based on a random write frame format, and the random write frame format consists sequentially of a start bit, an optical module address, a write flag bit, an optical module acknowledgment bit, an optical module register address, a first parity bit, first data, a second parity bit, ..., an Nth data bit, an (N+1)th parity bit, and a stop bit.

Further, the private read operation is based on a random read frame format, and the random read frame format consists sequentially of a start bit, an optical module address, a write flag bit, an optical module acknowledgment bit, an optical module register address, a parity bit, a repeated start bit, an optical module address, a read flag bit, an optical module acknowledgment bit, first data, a first frame termination bit, ..., Nth data, an Nth frame termination bit, and a stop bit.

Further, the current read operation is based on a current read frame format, and the current read frame format consists sequentially of a start bit, an optical module address, a read flag bit, an optical module acknowledgment bit, first data, a first frame termination bit, ..., Nth data, an Nth frame termination bit, and a stop bit.

Further, the optical module working method based on I3C communication further includes an error recovery method for optical module communication, wherein the error recovery method includes:
acquiring and recording, by the optical module MCU, the error source when the I3C peripheral enters an error interrupt;
enabling the I3C peripheral STOP interrupt in the error interrupt of the I3C peripheral and performing transmitting DMA channel configuration, wherein the transmitting DMA channel configuration specifically includes:
disabling the transmitting DMA request;
disabling the transmitting DMA channel;
clearing the TX-FIFO queue of the I3C; setting the transmitting DMA transmit byte length based on the maximum byte length of the extended payload page (EPL) in the CMIS protocol, wherein the transmitting DMA transmit byte length is greater than maximum byte length of the extended payload page (EPL);
modifying the transmitting DMA source address based on the CMIS memory mapping address where the current communication error occurs; enabling the transmitting DMA channel; and
enabling the transmitting DMA request; and enabling the I3C peripheral STOP interrupt in the error interrupt of the I3C peripheral and performing receiving DMA channel configuration, wherein the receiving DMA channel configuration specifically includes:
disabling the receiving DMA request;
disabling the receiving DMA channel; clearing the RX-FIFO queue of the I3C;
setting the receiving DMA receive byte length based on the maximum byte length of the extended payload page (EPL) in the CMIS protocol, wherein the receiving DMA receive byte length is greater than the sum of the maximum byte length of the extended payload edge (EPL) and one additional byte;
modifying the destination address of the receiving DMA to a memory area in the RAM of the optical module MCU as a receiving buffer;
enabling the receiving DMA channel; and enabling the receiving DMA request.

In a second aspect, an optical module is provided, wherein the working method of the optical module uses the optical module working method based on I3C communication as provided in the first aspect.

The beneficial effects of the present disclosure are as follows.

An optical module data processing working method combining I3C communication and DMA mechanism is provided. This method, based on functions such as dynamic address assignment and interrupts of I3C communication, enables the optical module to greatly improve communication rates and device management efficiency by leveraging the characteristics of I3C communication.

### BRIEF DESCRIPTION OF DRAWINGS

FIG. 1 is a hardware structure diagram of an optical module of the present disclosure;

FIG. 2 is a schematic diagram of a random write frame format in the optical module working method of the present disclosure;

FIG. 3 is a schematic diagram of a random read frame format in the optical module working method of the present disclosure;

FIG. 4 is a schematic diagram of a current read frame format in the optical module working method of the present disclosure; and

FIG. 5 is a flowchart of the optical module working method of the present disclosure.

### DETAILED DESCRIPTION OF EMBODIMENTS

To clarify the objectives, technical solutions, and advantages of the embodiments of the present disclosure, the technical solutions in the embodiments of the present disclosure will be clearly and completely described below with reference to the accompanying drawings. Obviously, the described embodiments are merely part of the embodiments of the present disclosure, but not all embodiments. The components of the embodiments of the present disclosure generally described and illustrated in the drawings herein may be arranged and designed in various different configurations.

With the development of optical communication technology, optical modules need to support higher bandwidth data transmission and lower power consumption. However, existing optical modules are generally based on the I2C protocol and use single-byte interrupts for data processing. This protocol has problems such as limited bandwidth, low data processing efficiency, relatively high power consumption, and insufficient scalability.

Therefore, the present disclosure intends to design an optical module working method based on the I3C protocol.

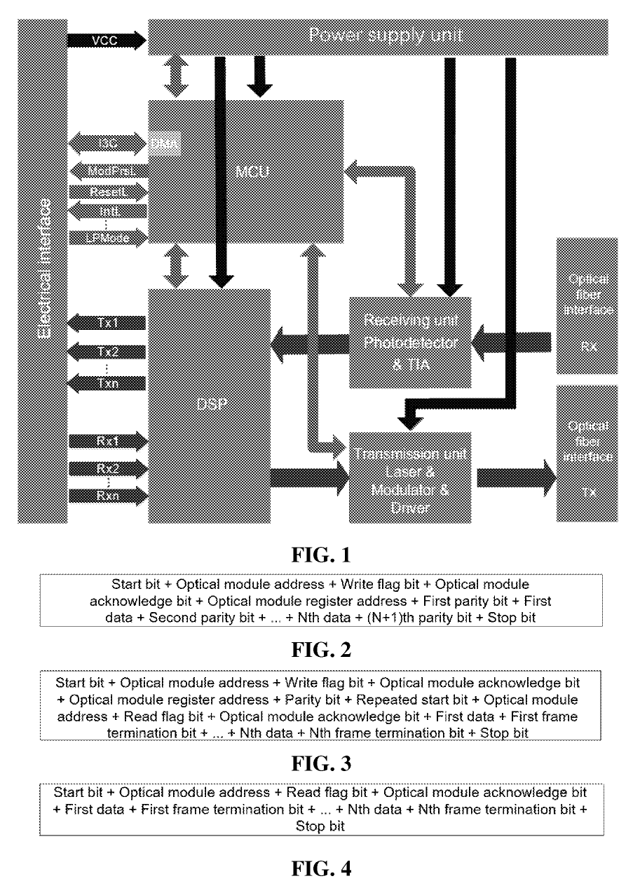

As shown in FIG. 1, first, the hardware architecture of the optical module in the present disclosure is clarified, which mainly includes an optical fiber interface, an electrical interface, a transmission unit, a reception unit, a DSP (Digital Signal Processor), an MCU, and a power supply unit.

The optical fiber interface is connected to the transmission unit and the reception unit, and is configured to transmit and receive optical signals. If it is an AEC (Active Electrical Cable) module, it does not include the reception and transmission units and the optical fiber interface in the above block diagram.

Electrical interface: 1. The electrical interface includes I3C SCL and SDA signal lines. The optical module is connected to the SCL and SDA buses of the I3C controller (switch, network card, etc.) through the I3C bus of the electrical interface/gold finger. The optical module, as a target device, performs I3C communication with the I3C controller. 2. Various low-speed signal control pins, such as ModPrsL (Module Present Low, module in-position detection signal (active low)), IntL (Interrupt Low, interrupt signal), LPMode (Low Power Mode), ModSel (Mode Selection, mode selection signal), and ResetL (Reset Low, reset signal), are configured to implement functions such as module presence indication, status indication, power mode control, module selection, and reset control. 3. The electrical interface includes high-speed signal line data pins, divided into differential signal pairs at the transmitter Tx1, Tx2...Txn (representing multiple independent transmission channels of the optical module) and differential signal pairs at the receiver Rx1, Rx2...Rxn (representing multiple independent reception channels of the optical module). 4. Power lines and ground wires are configured to supply power to the optical module.

Transmission unit mainly includes a laser, a modulator, and a driver, and is configured to convert electrical signals into optical signals and transmit them to the remote optical module reception unit via an optical fiber. If it is an AEC module, it does not include the reception and transmission units and the optical fiber interface in the above block diagram.

Reception unit mainly includes a photodetector and a TIA (Transimpedance Amplifier), and is configured to convert optical signals into electrical signals, amplify the electrical signals, and then output them to the DSP.

DSP is mainly configured to handle complex signal modulation and transmission issues, and it improves optical module performance and transmission quality through efficient digital signal processing algorithms. Some DSPs have integrated the driver in the aforementioned transmission unit and the TIA in the aforementioned reception unit.

MCU is the management core of the module, which is configured to coordinate and control the work of all parts of the module to ensure efficient operation of the module.

Power supply unit supplies power to the MCU, DSP, transmission unit, and reception unit.

Before describing the method of the present disclosure in detail, some technical terms based on the context of the present disclosure are first listed and explained.

Optical module is a key hardware module in optical communication systems for implementing mutual conversion between electrical signals and optical signals, and is configured for high-speed data transmission between network devices. The optical module further includes an MCU, which is formed by packaging a core, peripherals electrically connected to the core, and storage (Flash/RAM). The I3C peripheral in the present disclosure is the aforementioned peripheral that constitutes the MCU. The MCU, as the management core of the optical module, is configured to coordinate and control the works of all parts of the module to ensure efficient operation of the module, and the I3C peripheral is managed by the MCU core. The I3C peripheral is managed by the optical module MCU and works in accordance with the MIPI (Mobile Industry Processor Interface) protocol.

The I3C Controller, i.e., the master device, is an I3C peripheral located in hardware devices such as switches or network cards, and this peripheral acts as a Controller role, while the I3C peripheral of the optical module acts as a Target role.

The I3C peripheral in the present disclosure refers to a hardware module integrated in the MCU and supporting the I3C communication protocol. It can be configured into two roles: Target and Controller. The I3C peripheral of the optical module MCU is usually configured as a Target role, called as a slave device. The I3C peripheral in a hardware device such as a switch or a card network is usually configured as a Controller, called as a master device.

DMA (Direct Memory Access) is a technology configured for data transfer. In the present disclosure, it is configured to directly transfer data between peripherals and memory without the CPU intervening byte by byte, which can greatly improve efficiency and reduce power consumption.

DMA channel refers to a logical path configured to complete a specific data transfer task, just like a "conveyor belt", which automatically transfers data from one location to another based on a specific trigger signal.

STOP interrupt is an interrupt mechanism in the I3C peripheral. Its name may vary in hardware devices from different manufacturers. For example, in STM32 series products produced by STMicroelectronics, it can also be called as a completion interrupt.

Variable-length data refers to data frames or packets with non-fixed lengths. Correspondingly, traditional DMA communication can only transmit fixed-length data frames, meaning that the target device knows in advance the data length to be transmitted or received by the master device.

Enable refers to setting a functional module, subsystem, or signal path into an operational, responsive, or valid state by setting relevant control parameters, register bits, or logic signals, thereby executing a predetermined function. It usually indicates that the system has the authority or condition to execute a certain function.

Disable is the antonym of Enable. It refers to putting a specific function, module, or pathway into an inoperable, unresponsive, or invalid state by clearing or modifying the corresponding control parameters, register bits, or signal states to close, suspend, or stop the function.

EPL (Extended Payload Length) refers to maximum byte length of the extended payload page. In optical module management communication based on the CMIS (Common Management Interface Specification) protocol, data is exchanged in the form of command frames via I2C or I3C buses. The command frame usually includes fields such as Command Code, Payload Length, and data Payload. To adapt to large-capacity data transmission scenarios, the CMIS protocol introduces an EPL (Extended Payload Length) mechanism based on the standard Payload Length field. This field is enabled when the Payload Length field has the maximum value of 0xFF (255), and is configured to indicate that the actual data payload length exceeds 255 bytes. When the EPL mechanism is enabled, the original Payload field is stored and transmitted immediately after the EPL field. Through this mechanism, large-capacity data interaction scenarios such as EEPROM data block access and firmware download can be supported, which significantly improves the scalability and data throughput efficiency of the protocol.

Enable the 127th byte of Lower Memory: Lower Memory refers to an address space of 128 bytes, ranging from 0x00 to 0x7F. This area contains some global control and module status information. The 127th byte (address 0x7F) refers to the fact that in CMIS, the 127th byte (0x7F) is the Page Select byte, i.e., the page index. The page index value determines which page (or a page in a Bank) is accessed when the host accesses a byte in a page (address ranging from 128 to 255). Generally speaking, different "pages" can be accessed by writing different values (128 to 255) into this byte. Each "page" represents a complete 128-byte register mapping area, which is configured to access more information or control functions.

Based on the above explanation of technical terms, the method of the present disclosure is further elaborated as follows.

In the present disclosure, the optical module uses the I3C protocol for communication. Based on the advantages of the I3C protocol, dynamic address assignment can be achieved for the I3C peripheral in the optical module. When the I3C peripheral is assigned with a dynamic address, the I3C peripheral generates a dynamic address update interrupt. The optical module MCU monitors in real time whether it receives the dynamic address update interrupt generated by the I3C peripheral, and determines whether the I3C peripheral has completed address assignment based on the monitoring result.

It should be noted that while the optical module MCU is monitoring the dynamic address assignment of the I3C peripheral, the optical module can perform normal tasks. During dynamic address assignment, the I3C optical module can receive and respond to ENTDAA (Enter Dynamic Address Assignment) commands, RSTDAA (Reset Dynamic Address Assignment) commands, and SETNEWDA (Set New Dynamic Address) commands transmitted by the I3C controller, thereby dynamically assigning a 7-bit address to ensure the uniqueness of dynamic addresses on the I3C bus. It should be noted that the I3C Controller here, i.e., the master device, is an I3C peripheral located in hardware devices such as switches or network cards, and this peripheral acts as a Controller role, while the I3C peripheral of the optical module acts as a Target role.

When dynamic address assignment is successful, the hardware module in the optical module can communicate with the hardware module in the master device (such as a switch or network card) to perform internal system operations, thereby achieving access and modification of device-specific functions, configurations, or status information. The operations here mainly include the optical module MCU responding to the I3C controller's private read or private write operations based on operation instructions.

Before performing private read or private write operations, the I3C peripheral needs to be configured first. Specifically, it includes enabling the I3C peripheral STOP interrupt (it has different names among different hardware device manufacturers, such as completion interrupt in STM32 series products), which is configured to mark the end of DMA variable-length data transfer between the I3C receiving data register or I3C transmit data register and the optical module MCU memory. Its working principle is that when data transmission between the I3C receiving data register or I3C transmit data register and the optical module MCU memory (including the optical module MCU transmitting or receiving data) is completed, the optical module MCU immediately perceives the I3C peripheral STOP interrupt signal on the I3C bus (the process where the SDA level drops from 1 to 0 while SCL remains high level, i.e., the level falling edge). Variable-length data refers to data whose length is not fixed or unique, in contrast to the fixed-length data transmission of traditional DMA methods.

Here, the traditional DMA method of receiving data based on a preset fixed transmitted data length to determine whether reception is complete is not used; instead, it is based on the I3C peripheral STOP interrupt. For ease of understanding, taking the control device actually writing 2047 bytes of data as an example, after 2047 bytes are transmitted on the I3C hardware bus, an I3C STOP interrupt will be generated, but no transmitting DMA transfer complete interrupt will be generated (because at this time, the DMA has only transferred 2047 bytes of data, which is less than the maximum receive byte length of the receiving DMA of 2050 bytes). Then, further relevant processing after data reading completion can be performed in the I3C STOP interrupt, such as preparing for the next transmitter or receiver configuration to support the next private read or private write operation.

After the I3C peripheral configuration is completed, the receiving DMA channel bound to the I3C peripheral is configured to respond to the DMA private write operation. The private write here refers to a data write operation in which the I3C controller (master device) transmits data to the I3C receiving data register in the I3C peripheral of the optical module, and then transfers the data from the I3C receiving data register to the receiving buffer of the optical module MCU. That is to say, after the data is written into the I3C receiving data register, the data is then transferred to the optical module MCU memory through the DMA transmission mechanism. Therefore, before the data is further transferred to the optical module MCU memory, it is necessary to configure the DMA channel between the optical module MCU memory and the I3C peripheral in the optical module. Based on the optical module MCU, the DMA channel here is the receiving DMA channel. The specific content regarding the receiving DMA channel configuration is as follows: setting the source address of the receiving DMA to the I3C receiving data register in the I3C peripheral (the source address here can also be understood as the receiving address which is used by the I3C receiving data register in the I3C peripheral to receive, via the bus, the data transmitted by the master device (switch, network card, test card, etc.) for implementing private write); and setting the destination address of the receiving DMA to at least two memory areas in the RAM of the optical module MCU as receiving buffers (the objective of setting multiple receiving buffers is to use them alternately to receive multiple data).

In this embodiment, two receiving buffers can be provided, named the first receiving buffer and the second receiving buffer, respectively. The first receiving buffer and the second receiving buffer are two memory areas in the RAM of the I3C optical module MCU. In subsequent private write operations, the I3C optical module will alternately use the first receiving buffer and the second receiving buffer to receive data to implement a Ping-Pong mechanism, and the first receiving buffer is used here.

Regarding the Ping-Pong mechanism, based on multiple buffers, the first received data to be processed is cached in one of the receiving buffers and processed. When the data is still being processed and new data needs to be received and processed, the data is then stored in another receiving buffer and waits for the previous data to be processed before processing. Similarly, when new data is to be received and processed while the data in the current two buffers has not yet been processed, the data can be cached in a third receiving buffer. Under normal circumstances, setting two receiving buffers can basically meet most application scenarios, so in the embodiments of the present disclosure, two buffers are taken as examples.

It should also be noted that when there are multiple receiving buffers, a receiving priority can be set for each buffer. The objective is that when waiting to receive data, the address of the idle receiving buffer with the highest priority is configured as the destination address to receive data preferentially. When the previous data is still being processed and the occupied receiving buffer has not been freed, new data will be cached in the receiving buffer with the highest priority among the idle receiving buffers.

To cooperate with the I3C peripheral STOP interrupt to achieve variable-length data reception, the receiving DMA channel configuration further includes setting the receiving DMA receive byte length. This length setting is based on the maximum byte length of the EPL (Extended Payload Length) extended payload page in the CMIS (Common Management Interface Specification) protocol. It needs to be greater than the length of the maximum byte length of the extended payload page (EPL) plus one additional byte, that is, the receiving DMA receive byte length is greater than the sum of the maximum byte length of the extended payload edge (EPL) and one additional byte. This one byte refers to the address byte of the data register. For ease of understanding, an example is given as follows. One of the settings can be that when the current maximum length of EPL is 2048 bytes, an additional optical module data register address byte makes a total of 2049 bytes. Therefore, to achieve DMA variable-length reception, a length value greater than 2049 needs to be set. For example, when the receiving DMA receive byte length here is set to 2050 bytes, since the maximum EPL length is 2048 bytes and one additional byte of register length (totaling 2049 bytes) is needed, data greater than 2049 bytes will not be received during data reception, so the DMA transfer complete interrupt will not be triggered. At this point, whether the reception is complete can be determined based on identifying the I3C peripheral STOP interrupt, thereby achieving variable-length data reception.

After the above configuration is set, the receiving DMA channel and the receiving DMA request can be enabled, putting the DMA channel and DMA request in an available state, so that after the master device's private write data is transmitted to the I3C receiving data register in the optical module I3C peripheral, the corresponding DMA channel request of the I3C peripheral is triggered, and the data is transferred from the I3C receiving data register to the optical module MCU memory through the receiving DMA channel.

After the I3C peripheral is configured, the transmitting DMA channel bound to the I3C peripheral is configured to respond to the DMA private read operation. As can be seen from the above private write process, the private read refers to the I3C controller (master device) reading the data transferred by the memory area of the optical module MCU through DMA in the I3C transmitting data register in the I3C peripheral of the optical module. That is to say, the data transmission process of the private read is as follows: the optical module MCU transfers data to the I3C transmitting data register through the transmitting DMA channel, and the I3C transmitting data register then transmits the data to the I3C controller (master device). Similarly, before the optical module MCU transfers data to the I3C transmitting data register through the transmitting DMA channel, the transmitting DMA channel in the optical module needs to be configured first. The specific content is as follows.

The source address of the transmitting DMA is set as one memory area in the RAM of the optical module MCU as a transmitting buffer. In practice, specifically, the source address of the transmitting DMA is set as the Management Memory map specified in the CMIS protocol, which is the start address of the Lower Memory specified in the CMIS protocol, and is also one memory area in the RAM (Random Access Memory) of the I3C optical module MCU, named as the transmitting buffer here. At this time, if the I3C controller performs a Current Read operation, the content of the Lower Memory can be successfully read. It should be noted that the Lower Memory in CMIS refers to an address space of 128 bytes, ranging from 0x00 to 0x7F. This area contains some global control and module status information. Specifically, the 127th byte (address 0x7F) is configured for Page Select in CMIS. That is, different "pages" can be accessed by writing different values to the 127th byte. Each "page" represents a complete 128-byte register mapping area for accessing more information or control functions.

The destination address of the transmitting DMA is set as the I3C transmitting data register in the I3C peripheral. The destination address here can be understood as the transmitting address used by the I3C transmitting data register in the I3C peripheral to transmit the data for private reading to the master device (such as a switch, network card, or test card) via the bus.

Similarly, to cooperate with the I3C peripheral STOP interrupt to implement variable-length data transmission, it further includes the setting of the transmit byte length of the transmitting DMA. This length setting is based on the maximum byte length of the extended payload page (EPL) in the CMIS protocol, and the transmit byte length of the transmitting DMA only needs to be greater than the maximum byte length of the extended payload page (EPL). For ease of understanding, an example is given as follows: one of the settings can be that when the current maximum length of EPL is 2048 bytes, to implement DMA variable-length reception, it is necessary to set a length value greater than 2048, which can be set to 2049 bytes here, i.e., greater than the maximum byte length of the extended payload page (EPL). Different from the private read, the data in the private write also needs to carry a register address byte, so the receive byte length of the receiving DMA is set to 2050 bytes; while in the private read, since there is no register address byte in the data, it only needs to set to 2049 bytes.

After the above configuration is set, the transmitting DMA channel and the transmitting DMA request can be enabled to put the DMA channel and DMA request in an available state. When a private read request from the master device is received, the corresponding DMA channel request of the I3C peripheral is triggered, and the optical module MCU transfers data to the I3C transmitting data register through the transmitting DMA channel. Then the I3C transmitting data register transmits the data to the master device through the I3C bus.

The above content elaborates in detail the hardware device configuration before executing a private read operation or private write operation and the specific data transmission process during the private read or private write operation. Based on this configuration description and data transmission process description, the specific operation process and data communication principle when performing a private write or private read operation are described in detail next.

It should be noted that the triggering of a private write or private read operation is based on the operation instruction of the I3C controller (master device); that is, the optical module MCU will only perform the corresponding private write or private read operation after receiving the operation instruction of the I3C controller (master device).

First, the execution process of the private write operation is explained as follows.

Receiving and responding to the private write operation of the I3C controller.

When the optical module MCU receives the private write operation from the I3C controller, the private write data has already been transmitted by the I3C controller to the I3C receiving data register. In order to transfer the private write data in the I3C receiving data register to the receiving buffer in the optical module MCU, first the receiving DMA is triggered to transfer the data received in the I3C receiving data register from the receiving DMA source address (i.e., the address of the I3C receiving data register) into the first receiving buffer or the second receiving buffer in the receiving DMA destination address (the memory area address in the RAM of the optical module MCU). When data transmission of the private write is completed, an I3C peripheral STOP interrupt is generated based on the stop bit. The stop bit is the last byte in the private write data, as can be seen from the random write frame format defined later.

In practice, it can be specifically as follows: the receiving DMA is triggered by the non-empty flag of the RX-FIFO (Receive First-In-First-Out) buffer, and automatically transfers the received data from the source address of the receiving DMA (I3C receiving data register) to the destination address of the receiving DMA (the first receiving buffer and the second receiving buffer in the RAM of the optical module MCU alternately receive data). The data transferred by the DMA is the optical module register address in the random write frame format, and the first data to the Nth data. Data transmission of the private write is completed, and an I3C peripheral STOP interrupt is generated based on the stop bit to implement variable-length data reception.

Calculating the actual received data length in the STOP interrupt of the I3C peripheral.

After completing the data transfer work in the private write operation, it is also necessary to configure the I3C peripheral in the STOP interrupt of the I3C peripheral, configure the transmitting DMA channel bound to the I3C peripheral for the optical module to respond to the next private read operation of the I3C controller, and configure the receiving DMA channel bound to the I3C peripheral for the optical module to respond to the next private write operation of the I3C controller.

The I3C peripheral configuration is the same as the aforementioned I3C peripheral configuration before the DMA channel configuration for the private read or private write operation, which also enables the I3C peripheral STOP interrupt to implement the transfer of variable-length data between the I3C receiving data register or the I3C transmitting data register and the optical module MCU memory. Then the corresponding DMA channel is configured.

The private read is taken as an example first.

Before configuring the transmitting DMA channel again, first, it is necessary to disable the transmitting DMA request and the transmitting DMA channel, that is, the transmitting DMA is in a non-working state before the configuration is completed.

Then the TX-FIFO (Transmit First-In-First-Out) buffer queue of the I3C is cleared. Then, based on the maximum byte length of the extended payload page (EPL) in the CMIS protocol, the transmit byte length of the transmitting DMA is set, where the transmit byte length of the transmitting DMA is greater than the maximum byte length of the extended payload page (EPL). Same as above, the byte here can be set to 2049 bytes. The principle here is as mentioned above, and there are many principles later that can refer to the aforementioned content on DMA channel configuration, so it will not be repeated here and later.

Based on the optical module register address in the first receiving buffer and/or the second receiving buffer and the page mapping value of the 127th byte of Lower Memory, the transmitting source address is modified for the optical module to respond to the next current read operation. In practice, the transmitting source address, which is based on the Management Memory map specified in the CMIS protocol, is modified. The specific source address is determined according to the optical module register address in the most recently received receiving buffer (first receiving buffer or second receiving buffer) and the page mapping value of the 127th byte of Lower Memory. After the above work is completed, the reconfiguration of the transmitting DMA channel is completed. To respond to subsequent private read operations, the transmitting DMA channel and the transmitting DMA request are enabled at this time.

Similarly, to respond to a new private write operation, the specific configuration process is as follows.

Before configuring the receiving DMA channel again, first, it is necessary to disable the receiving DMA request and the receiving DMA channel, that is, the receiving DMA is in a non-working state before the configuration is completed.

The RX-FIFO queue of the I3C is cleared. The receiving DMA receive byte length based on the maximum byte length of the extended payload page (EPL) in the CMIS protocol is set, where the receiving DMA receive byte length is greater than the register length of the maximum byte length of the extended payload page (EPL) plus one byte. Same as above, the byte here can be set to 2050 bytes. The destination address of the receiving DMA is modified to two memory areas in the RAM of the optical module MCU as the first receiving buffer and the second receiving buffer. In subsequent private write operations, the first receiving buffer and the second receiving buffer are set alternately. The use of the Ping-Pong mechanism can minimize the risk of delay and data loss. After the above work is completed, the reconfiguration of the receiving DMA channel is completed. To respond to subsequent private write operations, the receiving DMA channel and the receiving DMA request are enabled at this time.

After the above DMA channel configuration is completed, the data in the first receiving buffer and/or the second receiving buffer is processed based on the Management Memory map in the CMIS protocol. The received data in the receiving buffer is the optical module register address in the random write frame format, and the first data to the Nth data (such as Data 1 to Data N in FIG. 2). Referring to the CMIS protocol, the optical module control register to be controlled by the I3C controller is located and correspondingly controlled based on the page mapping value of the current Lower Memory and the optical module register address.

As shown in FIG. 2, the random write frame format consists sequentially of a start bit, an optical module address, a write flag bit, an optical module acknowledge bit, an optical module register address, a first parity bit, first data, a second parity bit, ..., the Nth data, the (N+1)th parity bit, and a stop bit. For ease of understanding, each component in the frame format will be further explained.

Start bit (START) is the start condition on the I3C bus, configured to initiate a communication, usually initiated by the master device, and indicating the start of a new transaction.

Optical module address (Address) represents a 7-bit or dynamically assigned I3C device address, and is configured to uniquely identify the location of the target device (optical module).

Write flag bit (Write Bit): the value is 0, indicating that the master device will write data to the target device (at this time, it is the write register address).

Optical module acknowledge bit (ACK) represents a response bit from the target device to the address and direction bits. The line being pulled low indicates that the data has been successfully received and the device is ready for communication.

Optical module register address (Register Address) represents the register address within the specified target device for writing. This address will be used in subsequent reading.

Parity bit: after the master device is written into the optical module register address, an odd parity bit is appended to perform odd parity on the address byte, meaning that the number of "1" in all bits including the parity bit must be odd. If the odd parity fails, the target device may not respond or return an error flag, thus ensuring communication reliability.

Optical module acknowledge bit (ACK): the target device confirms again that it is ready to transmit data to the master device.

First data (Data 1) represents the first byte of data written to the register address, which is transmitted by the I3C controller.

Nth data (Data N) represents the last data byte.

Stop bit (STOP) indicates the completion of this communication and the release of the bus.

The above is the description of the execution process of the private write operation. Next, the working process of private read is briefly described as follows.

Receiving and responding to the private read operation of the I3C controller.

The transmitting DMA transfers data from the currently configured transmitting DMA source address into the I3C transmitting data register in the destination of the transmitting DMA. When data transmission of the private read is completed, an I3C peripheral STOP interrupt is generated based on the stop bit. In practice, the transmitting DMA automatically transfers data from the configured transmitting DMA source address to the transmitting DMA destination address (the I3C transmitting data register of the I3C peripheral). The source address here is determined by the optical module register address in the first receiving buffer and the second receiving buffer and the page mapping value of Lower Memory. The private read operation is based on the aforementioned random read frame format. After data transmission of the private read is completed, an I3C peripheral STOP interrupt is generated based on the stop bit.

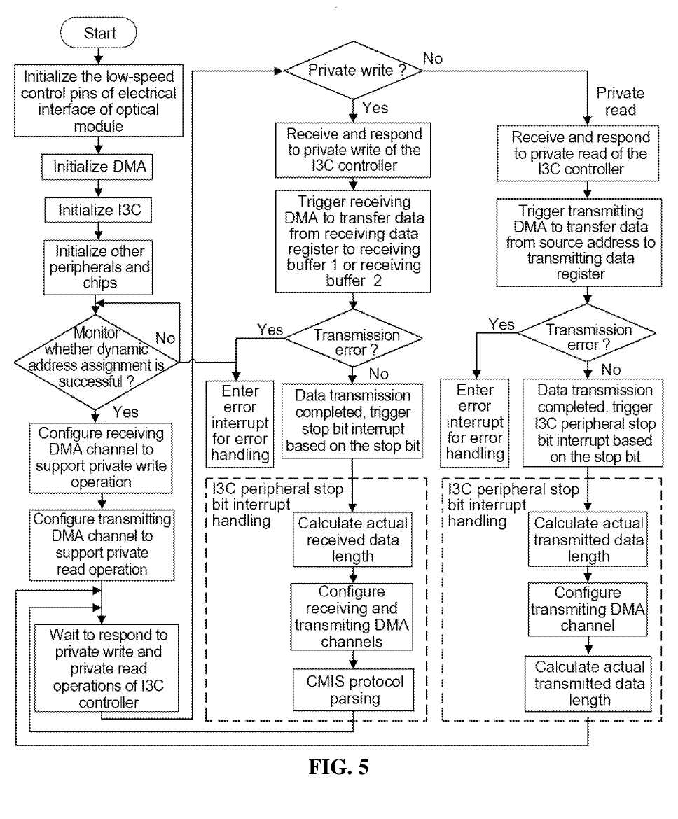

As shown in FIG. 3, the random read frame format consists sequentially of a start bit, an optical module address, a write flag bit, an optical module acknowledge bit, an optical module register address, a parity bit, a repeated start bit, an optical module address, a read flag bit, an optical module acknowledge bit, first data, a first frame termination bit, ..., the Nth data, the Nth frame termination bit, and a stop bit.

Repeated start bit (Repeated START) restarts a frame of communication without transmitting a STOP, and is configured to switch from a write operation to a read operation.

Optical module address (Address): the target device address is transmitted again to prepare for the upcoming read operation.

Read flag bit (Read Bit): a value of 1 indicates that the master device will read data from the target device.

First frame termination bit (T bit) represents response bit transmitted by the target device to inform the master device whether the target device itself continues data transmission.

T bit=1 indicates continuation of data transmission, and the transmission is ended by a stop signal.

T bit=0 indicates that the target device ends data transmission.

Nth frame termination bit (T bit) represents response bit transmitted by the target device to inform the master device whether the target device itself continues data transmission.

T bit=1 indicates continuation of data transmission, and the transmission is ended by a stop signal.

T bit=0 indicates that the target device ends data transmission. The actual transmitted data length is calculated in the I3C peripheral STOP interrupt.

After completing the data transfer in the private read operation, it is also necessary to configure the I3C peripheral in the STOP interrupt of the I3C peripheral, and configure the transmitting DMA channel bound to the I3C peripheral for the optical module to respond to the next private read operation of the I3C controller.

The I3C peripheral configuration is the same as the aforementioned I3C peripheral configuration before the DMA channel configuration for the private read or private write operation, which also enables the I3C peripheral STOP interrupt to implement the transfer of variable-length data between the I3C transmitting data register and the optical module MCU memory. Then the corresponding DMA channel is configured.

The process of reconfiguring the private read DMA channel is as follows. Before configuring the transmitting DMA channel again, first, it is necessary to disable the transmitting DMA request and the transmitting DMA channel, that is, the transmitting DMA is in a non-working state before the configuration is completed.

The TX-FIFO queue of the I3C is cleared. Then the transmit byte length is set based on the maximum byte length of the extended payload page (EPL) in the CMIS protocol. The transmit byte length of the transmitting DMA is greater than the maximum byte length of the extended payload page (EPL). Same as above, the byte here can be set to 2049 bytes.

Based on the optical module register address in the first receiving buffer and/or the second receiving buffer and the page mapping value of the 127th byte of Lower Memory, the transmitting source address is modified for the optical module to respond to the next current read operation. As shown in FIG. 4, the current read frame format consists sequentially of a start bit, an optical module address, a read flag bit, an optical module acknowledge bit, first data, a first frame termination bit, ..., the Nth data, the Nth frame termination bit, and a stop bit. After the above work is completed, the reconfiguration of the transmitting DMA channel is completed. To respond to subsequent private read operations, the transmitting DMA channel and the transmitting DMA request are enabled at this time.

After the above DMA channel configuration is completed, the data in the transmitting buffer is processed based on the Management Memory map in the CMIS protocol. It mainly includes read-clear operations on the registers of Lower Memory and upper page.

In addition, as shown in FIG. 5, before executing the above working method, it further includes:

Step 1: initializing the low-speed control pins of the electrical interface of the optical module;

Step 2: initializing DMA, specifically including:

Step 2.1: initializing the I3C transmitting DMA channel of the module:

Step 2.1.1: configuring the hardware request protocol of the transmitting DMA channel as burst;

Step 2.1.2: configuring the direction of the transmitting DMA as memory to peripheral;

Step 2.1.3: configuring the DMA source address mode as self-increment mode;

Step 2.1.4: configuring the DMA destination address mode as fixed mode;

Step 2.2: initializing the I3C receiving DMA channel of the module:

Step 2.2.1: configuring the hardware request protocol of the receiving DMA channel as burst;

Step 2.2.2: configuring the direction of the receiving DMA as peripheral to memory;

Step 2.2.3: configuring the DMA source address mode as fixed mode;

Step 2.2.4: configuring the DMA destination address mode as self-increment mode;

Step 3: initializing the I3C peripheral, mainly including the following configurations:

Step 3.1: configuring the optical module as an I3C Target;

Step 3.2: configuring the Provisioned ID (preconfigured identifier);

Step 3.3: setting the maximum read data length to 2048 bytes to support the reading of the extended payload page (EPL) with a maximum length of 2048 bytes specified in the CMIS protocol;

Step 3.4: setting the maximum write data length to 2049 to support the simultaneous writing of the extended payload page (EPL) with a maximum length of 2048 bytes specified in the CMIS protocol plus 1 byte of optical module register address;

Step 3.5: configuring to support the maximum transmission rate (In SDR (Single Data Rate) mode, it supports a maximum bandwidth of 12.5 Mbps);

Step 3.6: enabling the I3C transmission completion interrupt and the I3C error interrupt;

Step 3.7: enabling the event response interrupt for I3C CCC (Common Command Codes) instructions including the dynamic address assignment instruction ENTDAA; and

Step 4: initializing the DSP, the transmission unit, and the receiving unit.

The aforementioned optical module working method based on I3C communication transfers data from the I3C peripheral to the RAM of the I3C optical module MCU through DMA after receiving data transmitted by the I3C controller from the I3C bus, and transfers data from the RAM of the I3C optical module MCU to the I3C peripheral through DMA. This method using DMA transmission can improve I3C communication throughput and reduce CPU load.

According to the maximum length of the extended payload edge (EPL) in the CMIS protocol, by setting the transmission length of data transmitted and received by DMA to be longer than the data length actually received and transmitted by the I3C optical module, and combining with the completion interrupt of the I3C peripheral, the variable-length transmission of DMA is implemented.

Using the Ping-Pong mechanism during data reception by the I3C optical module, that is, alternately using the first receiving buffer and the second receiving buffer for data reception, can minimize the risk of delay and data loss. The destination address of the receiving DMA is two memory areas defined in the RAM of the I3C optical module MCU, named here as receiving buffer 1 and receiving buffer 2 respectively. In the private write operation, the I3C optical module will alternately use the first receiving buffer and the second receiving buffer for data reception to implement the Ping-Pong mechanism.

The above method has the following advantages.

1. It improves the communication rate of the optical module to meet the high-bandwidth demand.

Optical modules need to handle high-speed data transmission in modern communications, and the I3C protocol can support SDR mode with a maximum bandwidth of 12.5 Mbps and HDR-DDR mode with a communication bandwidth of 25 Mbps, thereby significantly improving the bus communication rate and meeting the optical module's requirements for high bandwidth and high rate. Compared to Fast Mode Plus (1 Mbps) used in traditional I2C module practice, I3C achieves an order of magnitude improvement in data throughput, thereby accelerating the efficiency of data transmission and control command processing between the optical module and the master device. It is especially suitable for application scenarios that require high-speed and large-volume data exchange, such as firmware update for optical module MCUs and DSPs. For firmware download of the same size, it takes 20.34 seconds to update the firmware using I2C as the master device test board and the I2C optical module, while it only takes 6.28 seconds to update the firmware using I3C as the controller test board and the I3C optical module.

2. DMA is configured for data transmission to reduce MCU occupancy and improve real-time performance.

Using DMA for data transmission reduces MCU occupancy, avoids frequent entry into interrupts to process data transmission and reception, enables other tasks of the optical module to run more smoothly, and improves the real-time performance of the optical module.

3. Low power consumption operation is achieved.

The present disclosure utilizes the low power consumption characteristics of the I3C protocol, enabling the I3C bus of the optical module to automatically enter a low power consumption mode in a non-communication state, thereby reducing the overall energy consumption of the optical module. Especially in scenarios with dense deployment of a large number of devices, this optimization can significantly reduce the overall power consumption, extend the service life of the optical module, and reduce maintenance costs.

4. It can improve the stability of the optical module and reduce signal interference.

The improved design of the I3C protocol includes better signal integrity and bus arbitration mechanism, which can reduce communication conflicts and signal interference inside the optical module. Through these characteristics, the present disclosure improves the stability and reliability of the optical module and ensures the long-term stable operation of the system.

In addition to disclosing the above working method process, the present disclosure further proposes an error recovery method for optical module communication, wherein the error recovery method includes:
acquiring and recording, by the optical module MCU, the error source when the I3C peripheral enters an error interrupt; and
configuring and enabling the I3C peripheral STOP interrupt and perform transmitting DMA channel configuration in the error interrupt of the I3C peripheral, wherein the transmitting DMA channel configuration specifically includes:
first, disabling the transmitting DMA request and the transmitting DMA channel, that is, the transmitting DMA being in a non-working state before the configuration is completed; then clearing the TX-FIFO (Transmit First-In-First-Out) buffer queue of the I3C; then setting the transmit byte length of the transmitting DMA based on the maximum byte length of the extended payload page (EPL) in the CMIS protocol, where the transmit byte length of the transmitting DMA is greater than the maximum byte length of the extended payload page (EPL); same as above, the byte here can be set to 2049 bytes; then modifying the source address of the transmitting DMA based on the CMIS memory mapping address where the current communication error occurs; then enabling the transmitting DMA channel and the transmitting DMA request, wherein the modifying the source address of the transmitting DMA in practice specifically indicates: modifying the source address of the transmitting DMA, in which the address is based on the Management Memory map specified in the CMIS protocol, and the specific source address is the CMIS memory mapping address where the current communication error occurs, thereby enabling the I3C controller to read the data from the previous "random read" operation that had a communication error when performing the next "current read" operation; and
configuring and enabling the I3C peripheral completion interrupt and perform receiving DMA channel configuration in the error interrupt of the I3C peripheral, wherein the receiving DMA channel configuration specifically includes:
before configuring the receiving DMA channel again, first disabling the receiving DMA request and the receiving DMA channel, that is, the receiving DMA being in a non-working state before the configuration is completed; clearing the I3C's RX-FIFO queue; setting the receiving DMA receive byte length based on the maximum byte length of the extended payload page (EPL) in the CMIS protocol, where the receiving DMA receive byte length is greater than the maximum byte length of the extended payload page (EPL) plus one byte of register length; same as above, the byte here can be set to 2050 bytes; modifying the destination address of the receiving DMA to a memory area in the RAM of the optical module MCU as the receiving buffer; then enabling the receiving DMA channel and the receiving DMA request.

Based on the above optical module working method, an optical module is further provided, and the working method of this optical module uses the aforementioned optical module working method based on I3C communication.

The above contents are only preferred embodiments of the present disclosure and is not intended to limit the present disclosure. For those skilled in the art, various modifications and changes can be made to the present disclosure. Any modification, equivalent substitution, improvement, etc. made within the spirit and principles of the present disclosure shall fall within the protection scope of the present disclosure.

1. An optical module working method based on I3C communication, comprising following steps:
monitoring, by an optical module MCU, a dynamic address update interrupt generated by an I3C peripheral, to continuously monitor whether a dynamic address has been assigned by an I3C controller, wherein the I3C peripheral is a peripheral electrically connected to a core of the optical module MCU; and
when successful dynamic address assignment is monitored, configuring the I3C peripheral, a receiving DMA channel bound to the I3C peripheral, and a transmitting DMA channel bound to the I3C peripheral; after completing the configuration, waiting for the I3C controller to issue an operation instruction; and when receiving the operation instruction, responding, by the optical module MCU, to a private read operation or a private write operation initiated by the I3C controller.

2. The optical module working method based on I3C communication according to claim 1, wherein when successful dynamic address assignment is monitored, configuring the I3C peripheral, a receiving DMA channel bound to the I3C peripheral, and a transmitting DMA channel bound to the I3C peripheral comprises enabling an I3C peripheral STOP interrupt for cooperating with the receiving DMA channel to receive variable-length data transmitted by the I3C controller, and configuring the receiving DMA channel to respond to a DMA private write operation, wherein the configuring the receiving DMA channel comprises:
setting a source address of a receiving DMA to an I3C receiving data register in the I3C peripheral;
setting a destination address of the receiving DMA to at least two memory areas in a RAM of the optical module MCU as receiving buffers;
setting a receive byte length of the receiving DMA based on a maximum byte length of an extended payload page (EPL) in a common management interface specification protocol, wherein the receive byte length of the receiving DMA is greater than a sum of the maximum byte length of the extended payload edge (EPL) and one additional byte;
enabling the receiving DMA channel; and
enabling a receiving DMA request.

3. The optical module working method based on I3C communication according to claim 1, wherein when successful dynamic address assignment is monitored, configuring the I3C peripheral, a receiving DMA channel bound to the I3C peripheral, and a transmitting DMA channel bound to the I3C peripheral comprises configuring and enabling an I3C peripheral STOP interrupt for cooperating with the transmitting DMA channel to transmit variable-length data to the I3C controller, and configuring the transmitting DMA channel to respond to a DMA private read operation, wherein the configuring the transmitting DMA channel comprises:
setting a source address of a transmitting DMA to one memory area in a RAM of the optical module MCU as a transmitting buffer;
setting a destination address of the transmitting DMA to an I3C transmit data register in the I3C peripheral;
setting a transmit byte length of the transmitting DMA based on a maximum byte length of an extended payload page (EPL) in a common management interface specification protocol, wherein the transmit byte length of the transmitting DMA is greater than the maximum byte length of the extended payload page (EPL);
enabling the transmitting DMA channel; and
enabling a transmitting DMA request.

4. The optical module working method based on I3C communication according to claim 2, wherein a working process of the private write is as follows:
after the receiving DMA is triggered, transferring received data from the source address of the receiving DMA into the receiving buffer in the destination address of the receiving DMA; when data transmission of the private write is completed, generating an I3C peripheral STOP interrupt based on a stop bit in the data to achieve variable-length data reception by the receiving DMA;calculating an actual received data length in the I3C peripheral STOP interrupt;configuring the I3C peripheral and the transmitting DMA channel bound to the I3C peripheral in the I3C peripheral STOP interrupt, for the optical module to respond to a next private read operation of the I3C controller;configuring the I3C peripheral and the receiving DMA channel bound to the I3C peripheral in the I3C peripheral STOP interrupt, for the optical module to respond to a next private write operation of the I3C controller; andprocessing the data in the receiving buffer based on a management memory map in the common management interface specification protocol.

5. The optical module working method based on I3C communication according to claim 3, wherein a working process of the private read is as follows:
upon the transmitting DMA being triggered, transferring, by the transmitting DMA, data from a currently configured source address of the transmitting DMA into the destination address of the transmitting DMA; when data transmission of the private read is completed, generating an I3C peripheral STOP interrupt based on a stop bit in the data to achieve variable-length data transmission by the transmitting DMA;calculating an actual transmitted data length in the I3C peripheral STOP interrupt;configuring the I3C peripheral and the transmitting DMA channel bound to the I3C peripheral in the I3C peripheral STOP interrupt, for the optical module to respond to a next private read operation of the I3C controller; andprocessing the data in the transmitting buffer based on a management memory map in the common management interface specification protocol.

6. The optical module working method based on I3C communication according to claim 4, wherein the configuring the I3C peripheral and the receiving DMA channel bound to the I3C peripheral in the I3C peripheral STOP interrupt, for the optical module to respond to a next private write operation of the I3C controller comprises: disabling the receiving DMA request;disabling the receiving DMA channel;clearing a RX-FIFO queue of the I3C;setting the receive byte length of the receiving DMA based on the maximum byte length of the extended payload page (EPL) in the common management interface specification protocol, wherein the receive byte length of the receiving DMA is greater than the sum of the maximum byte length of the extended payload edge (EPL) and one additional byte;modifying the destination address of the receiving DMA to a memory area in the RAM of the optical module MCU as a receiving buffer;enabling the receiving DMA channel; andenabling the receiving DMA request.

7. The optical module working method based on I3C communication according to claim 4, wherein the configuring the I3C peripheral and the transmitting DMA channel bound to the I3C peripheral in the I3C peripheral STOP interrupt, for the optical module to respond to a next private read operation of the I3C controller comprises:
disabling the transmitting DMA request;
disabling the transmitting DMA channel;
clearing a TX-FIFO queue of the I3C;
setting the transmit byte length of the transmitting DMA based on the maximum byte length of the extended payload page (EPL) in the common management interface specification protocol, wherein the transmit byte length of the transmitting DMA is greater than maximum byte length of the extended payload page (EPL);
modifying a transmitting source address based on an optical module register address in the receiving buffer and a page mapping value of the 127th byte of Lower Memory, for the optical module to respond to a next current read operation;
enabling the transmitting DMA channel; and
enabling the transmitting DMA request.

8. The optical module working method based on I3C communication according to claim 6, wherein the private write operation is based on a random write frame format, and the random write frame format consists sequentially of a start bit, an optical module address, a write flag bit, an optical module acknowledgment bit, an optical module register address, a first parity bit, first data, a second parity bit, ..., an Nth data bit, an (N+1)th parity bit, and a stop bit.

9. The optical module working method based on I3C communication according to claim 7, wherein the private read operation is based on a random read frame format, and the random read frame format consists sequentially of a start bit, an optical module address, a write flag bit, an optical module acknowledgment bit, an optical module register address, a parity bit, a repeated start bit, an optical module address, a read flag bit, an optical module acknowledgment bit, first data, a first frame termination bit, ..., Nth data, an Nth frame termination bit, and a stop bit.

10. The optical module working method based on I3C communication according to claim 7, wherein the current read operation is based on a current read frame format, and the current read frame format consists sequentially of a start bit, an optical module address, a read flag bit, an optical module acknowledgment bit, first data, a first frame termination bit, ..., Nth data, an Nth frame termination bit, and a stop bit.

11. The optical module working method based on I3C communication according to claim 1, further comprising an error recovery method for optical module communication, wherein the error recovery method comprises: acquiring and recording, by the optical module MCU, an error source when the I3C peripheral enters an error interrupt;enabling the I3C peripheral STOP interrupt in the error interrupt of the I3C peripheral and performing transmitting DMA channel configuration, wherein the transmitting DMA channel configuration comprises: disabling a transmitting DMA request; disabling a transmitting DMA channel; clearing a TX-FIFO queue of the I3C; setting a transmit byte length of a transmitting DMA based on a maximum byte length of an extended payload page (EPL) in a common management interface specification protocol, wherein the transmit byte length of the transmitting DMA is greater than the maximum byte length of the extended payload page (EPL); modifying a source address of the transmitting DMA based on a memory mapping address of common management interface specification where a current communication error occurs; enabling the transmitting DMA channel; and enabling the transmitting DMA request; andenabling the I3C peripheral STOP interrupt in the error interrupt of the I3C peripheral and performing receiving DMA channel configuration, wherein the receiving DMA channel configuration comprises: disabling a receiving DMA request; disabling a receiving DMA channel; clearing the RX-FIFO queue of the I3C; setting a receive byte length of a receiving DMA based on the maximum byte length of the extended payload page (EPL) in the common management interface specification protocol, wherein the receive byte length of the receiving DMA is greater than a sum of the maximum byte length of the extended payload edge (EPL) and one additional byte; modifying a destination address of the receiving DMA to a memory area in the RAM of the optical module MCU as a receiving buffer; enabling the receiving DMA channel; and enabling the receiving DMA request.

12. An optical module, wherein a working method of the optical module uses the optical module working method based on I3C communication according to claim 1.
